(19) United States
(12) Patent Application Publication
(10) Pub. No.: US 2023/0263233 A1
(43) Pub. Date: Aug. 24, 2023

(54) Aerosol Generating Device with a Flow Rate Sensor

(71) Applicant: JT International SA, Geneva (CH)

(72) Inventors: Alec Wright, Guildford (GB); Andrew Robert John Rogan, Forres (GB)

(73) Assignee: JT International SA, Geneva (CH)

(21) Appl. No.: 18/012,336

(22) PCT Filed: Jun. 21, 2021
(86) PCT No.: PCT/EP2021/066860

§ 371 Date: Dec. 22, 2022

(30) Foreign Application Priority Data
Jun. 25, 2020 (EP) 20182373.9

(51) Int. Cl. A24F 40/51; G01N 11/04; A24F 40/10; A24F 40/48; A24F 40/42

(52) U.S. Cl. CPC A24F 40/51; G01N 11/04; A24F 40/10; A24F 40/48; A24F 40/42

(57) ABSTRACT

An aerosol generating device configured to generate an aerosol for inhalation by a user includes: a heater configured to heat an aerosol forming fluid to a predetermined temperature; a sensor configured to measure a parameter which is related to the flow rate of the heated aerosol forming fluid; and a controller configured to enable or disable the generation of an aerosol based on the measured parameter.

### FIELD OF INVENTION

The invention relates to aerosol generating devices. In particular, the invention relates to an aerosol generating device with a flow rate sensor.

### BACKGROUND TO THE INVENTION

There is a demand for aerosol generating devices with improved safety features, such as safety features which prevent the use of harmful or unauthorised aerosol generating fluids with the aerosol generating device. It is an object of the present invention to address this demand.

### SUMMARY OF INVENTION

According to a first aspect of the invention, there is provided an aerosol generating device configured to generate an aerosol for inhalation by a user, comprising: a heater configured to heat an aerosol forming fluid to a predetermined temperature; a sensor configured to measure a parameter which is related to the flow rate of the heated aerosol forming fluid; and a controller configured to enable or disable the generation of an aerosol based on the measured parameter.

In this way, the security of the device is enhanced because the generation of an aerosol can be enabled only if the flow rate of the aerosol generating fluid meets a safety criteria. In one example, the safety criteria can be that the flow rate of the aerosol generating fluid matches the flow rate of authorised aerosol generating fluids, at the predetermined temperature. In general, the flow rate of an aerosol generating fluid is strongly dependent on the ratios of the component fluids and can also be affected by the inclusion of potentially harmful substances. Thus, the flow rate can be used as a reliable indicator of the authenticity of the aerosol generating fluid. Heating the fluid to a predetermined temperature before measuring with the flow rate sensor increases the reliability of the authorisation, because the measurement performed by the sensor is less affected by varying ambient temperatures. Pre-heating the aerosol forming fluid in this way has an additional benefit in that it can increase the safety of the device when used with authorised aerosol generating fluids. If the measured flow rate exceeds the known flow rate for an authorised fluid, this can indicate that the device may be operating at higher temperatures than is safe for battery usage. In some examples, a portion of aerosol generating fluid may be heated to the predetermined temperature. The heater may be configured to heat a portion of the aerosol generating fluid which is upstream of the flow rate sensor to the predetermined temperature. Alternatively, the heater may be configured to heat all of the aerosol generating fluid upstream of the flow rate sensor to the predetermined temperature.

Preferably the measured parameter is the flow rate itself. However, it may also be possible to measure different parameters which are related to the flow rate by some simple function.

Preferably, the aerosol generating device comprises a pump configured to pump the aerosol forming fluid. In this way, the aerosol generating fluid can be pumped towards the flow rate sensor for measurement. The pump may also be used in order to pump the aerosol generating fluid to a desired location for aerosol generation. Using a pump can provide a stable fluid delivery to the desired location for a more consistent generation of the aerosol in comparison to other delivery methods, such as capillary action.

Preferably, the pump is configured to provide pumping at a fixed pumping power, which is the applied pressure by the pump. In this way, the flow rate can be compared to other flow rates more simply using the known fixed pumping power of the pump.

In some embodiments, the controller is further configured calculate the viscosity of the aerosol generating fluid based on the measured flow rate, and to enable or disable the generation of the aerosol based on the calculated viscosity. In this way, an alternative or additional characteristic can be tested in order to verify the authenticity of the aerosol generating fluid.

Preferably, the predetermined temperature is above 35° C. In this way, the predetermined temperature is higher than most ambient temperatures a user is likely to encounter. More preferably, the predetermined temperature is between 40° C. and 70° C. In this way, the predetermined temperature can safely be considered higher than the ambient temperature while being low enough so as not to cause undue battery strain. Additionally, when a pump is also provided, the temperature is not so high as to reduce the efficiency of the pump, which can occur as the viscosity of the fluid decreases with increasing temperature.

Preferably, the aerosol generating device further comprises a memory configured to store a value associated with the measured parameter related to flow rate, and wherein the controller is configured to enable or disable the generation of an aerosol based on a comparison with the stored value. In this way, the measured flow rate of the aerosol generating fluid can be compared with a list of flow rates of known or authorised aerosol generating fluids, as measured at the predetermined temperature, in order to verify the aerosol generating fluid.

Preferably, the aerosol generating device further comprises a temperature sensor configured to determine the temperature of the aerosol forming fluid. In this way, the temperature of the aerosol generating fluid can be monitored so that the flow rate sensor can measure the flow rate of the aerosol generating fluid when the fluid is known to be at the predetermined temperature.

In some embodiments, the aerosol generating device further comprises a reservoir for containing an aerosol forming fluid. The reservoir may be configured as a refillable reservoir. In this way, the aerosol generating fluid can be received by the aerosol generating device and measured using the flow rate sensor provided on the aerosol generating device. Providing the aerosol generating device with a reservoir can be a cost-effective solution which avoids the need to provide a flow rate sensor and a heater on a disposable cartridge.

In some embodiments, the reservoir is provided on a cartridge. The cartridge may be a disposable cartridge or a refillable cartridge. In this way, the user can more conveniently replenish the supply of aerosol generating fluid to the aerosol generating device.

In some embodiments wherein the aerosol generating device comprises a reservoir provided on a cartridge, the aerosol generating device comprises a reusable unit, wherein: the reusable unit and the cartridge are configured to be attachable and detachable from one another; and the controller is provided on the reusable unit.

In some embodiments wherein the aerosol generating device comprises a pump, the sensor, the pump and the heater are provided on the cartridge, and the cartridge is configured to be refillable. In this way, the flow rate measurement can be carried out entirely on the cartridge, without the transfer of fluid between the cartridge and the reusable unit. This is advantageous because the possibility of internal spillage of the aerosol generating fluid at a fluid connection point between the cartridge and the reusable unit is eliminated.

Preferably, the aerosol generating device further comprises control electronics configured to permit the generation of an aerosol when the reusable unit and the cartridge are attached. In this way, the safety of the device is increased because the generation of an aerosol cannot be enabled while the reusable unit and the cartridge are detached.

According to a second aspect of the invention, there is provided a method of operating an aerosol generating device according to the first aspect of the invention to generate an aerosol, comprising the steps of: heating an aerosol forming fluid to a predetermined temperature; measuring a parameter which is related to the flow rate of the heated aerosol forming fluid; and enabling or disabling the generation of an aerosol based on the measured parameter.

According to a third aspect of the invention, there is provided a non-transitory computer readable medium comprising executable instructions that, when executed by a processor on an aerosol generating device according to the first aspect of the invention, cause the aerosol generating device to perform steps comprising: heating an aerosol forming fluid to a predetermined temperature; measuring a parameter which is related to the flow rate of the heated aerosol forming fluid; and enabling or disabling the generation of an aerosol based on the measured parameter.

### BRIEF DESCRIPTION OF THE DRAWINGS

Embodiments of the invention are now described, by way of example, with reference to the drawings, in which:

FIG. 1 is a cross-sectional schematic diagram of an aerosol generating device in a first embodiment of the invention;

FIG. 2 is a schematic block diagram of a control system in an aerosol generating device in an embodiment of the invention;

FIG. 3 is a cross-sectional schematic diagram of an aerosol generating device in a second embodiment of the invention;

FIG. 4 is a cross-sectional schematic diagram of an aerosol generating device in a third embodiment of the invention;

FIG. 5 is a flowchart showing a control sequence in an embodiment of the invention; and

FIG. 6 is a cross-sectional schematic diagram of an aerosol generating device in a fourth embodiment of the invention.

### DETAILED DESCRIPTION OF THE DRAWINGS

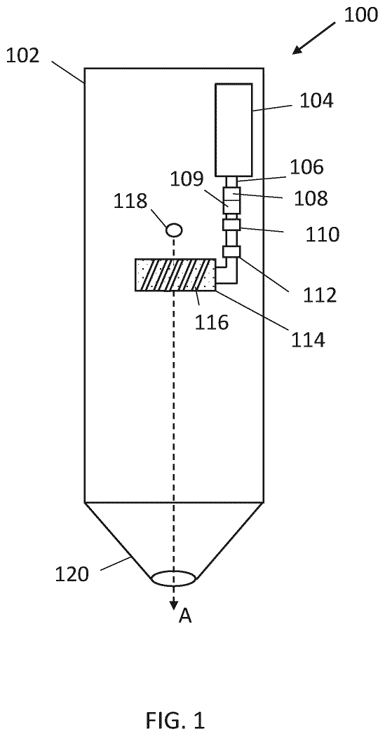

FIG. 1 is a cross-sectional view of an aerosol generating device in an embodiment of the invention.

A first aerosol generating device 100 is provided and comprises a housing 102 which houses the internal components of the device. A reservoir 104 is provided for the storage of an aerosol generating fluid. A conduit 106 is provided for the transportation of the aerosol generating fluid from the reservoir 104. A first heater 108 is provided in thermal communication with the conduit 106 in order to provide heating to aerosol generating fluid inside the conduit 106 up to a predetermined temperature. A temperature sensor 109 is provided for measuring the temperature of the aerosol generating fluid in the conduit 106. A pump 110 is provided to pump the aerosol generating fluid from the reservoir 104 through the conduit 106. A flow rate sensor 112 is provided for measuring the flow rate of the aerosol generating fluid as the aerosol generating fluid is pumped through the conduit 106. A wick 114 is provided for the absorption of the aerosol generating fluid which is pumped through the conduit 106. A second heater is provided in the form of an electrically resistive coil 116 wrapped around the wick 114. The coil 116 is configured to generate heat when an electric current is passed through the coil 116 in order to vaporise the aerosol generating fluid absorbed by the wick 114. An air inlet 118 is provided on the housing 102 in fluid connection with a mouthpiece 120 via an air channel (A) to enable a user to draw air through a mouthpiece 120. The wick 114 and the coil 116 are provided within the air channel (A), which enables the user to inhale the generated aerosol by inhaling through the mouthpiece 120. The first aerosol generating device 100 also comprises a battery (not shown) for powering the device.

The housing 102 may comprise any suitable material known in the art, such as plastic or metal.

In the embodiment of FIG. 1, the reservoir 104 is configured as a refillable reservoir configured to be refilled using an external reservoir storing an aerosol generating fluid. In one example embodiment, the reservoir 104 may be accessed by a screw cap or a lid on the housing 102, and refilled by opening a valve or seal in fluid connection with the reservoir 104 which enables aerosol generating fluid to be poured into the reservoir 104. In another example embodiment, the reservoir 104 may comprise a pierceable member. In such an example, the reservoir 104 may be refilled by piercing the pierceable member with a needle and pumping an aerosol generating fluid through the needle into the reservoir 104.

The conduit 106 may comprise any suitable material, such as plastic or metal. The material of the conduit 106 may be chosen so that the material is resistant to the operational temperatures of the first heater 108.

The first heater 108 may be provided as an electrically resistive plate of metal wrapped around the conduit 106 in order to provide heating to the conduit 106 when an electric current is applied to the plate. In the example embodiment of FIG. 1, the first heater 108 is configured to heat a portion of the aerosol generating fluid which is ‘upstream’ of the flow rate sensor 112, as defined from the reservoir 104 to the wick 114 along the direction of fluid flow. This may be more energy efficient in comparison to heating all of the aerosol generating fluid which is upstream of the flow rate sensor 112. In other example embodiments, the first heater 108 may be configured to heat all of the aerosol generating fluid which is upstream of the flow rate sensor 112. Alternatively, the first heater 108 may be provided in thermal communication with the reservoir 104 in order to heat the fluid while it is inside the reservoir 104. In a further example, the first heater 108 may be configured to heat the aerosol forming fluid while it is inside the flow rate sensor 112. In other examples, the first heater 108 may heat the aerosol generating fluid in other ways. The first heater 108 may be provided as a resistive element inside the conduit 106 or the reservoir. Alternatively, the first heater 108 may be a convective heater or an induction heater.

The temperature sensor 109 may be any suitable temperature sensor known in the art, such as a thermocouple or a thermistor. The temperature 109 may be provided internally within the conduit 106 in order to measure the temperature of the aerosol generating fluid within the conduit 106. Alternatively, the temperature sensor 109 may be provided external to the conduit 106.

In the example of FIG. 1, the pump 110 is a micro-pump which is configured to operate at fixed pumping power, i.e. fixed pressure applied to the fluid by the pump. In other examples, the pump 110 may be any kind of pump suitable for pumping aerosol generating fluid through the conduit 106 at temperatures around the predetermined temperature. In an alternative embodiment, the pump 110 may be provided along the path of fluid flow at a position between the flow rate sensor 112 and the wick 114.

The flow rate sensor 112 may be any suitable flow rate sensor capable of determining the flow rate of the aerosol generating fluid. The flow rate sensor 112 may comprise a fluid inlet on a first side of the flow rate sensor 112 to receive the aerosol generating fluid from the conduit 106, and a fluid outlet on a second side to provide the aerosol generating fluid to the conduit 106 after the flow rate has been measured. In one example, the flow rate sensor 112 may comprise a wheel which is turned by the aerosol generating fluid which is pumped through the flow rate sensor 112. The flow rate sensor 112 may determine rotational speed of the wheel to infer the flow speed of the fluid. In another example, the flow rate sensor 112 may comprise a MEMS flow rate sensor. MEMS flow rate sensors operate using a thermal sensor to determine the flow rate of a fluid flowing through the sensor. The flow rate of the fluid can be determined based on the known thermal properties of the fluid and the amount of cooling the received by thermal sensor from the flowing fluid. The known thermal properties of the fluid can be stored, for example, in a memory of the first aerosol generating device 100.

The wick 114 may comprise any suitable porous material as is known in the art, such as yarn or ceramic. It is considered that the wick 114 and coil 116 arrangement of FIG. 1 may, in other example embodiments, be replaced with any other apparatus configured to generate an aerosol using an aerosol generating fluid. In one example, the wick 114 may comprise a cotton pad and the coil 116 may be replaced with an electrically resistive plate in thermal contact with the cotton pad. In another alternative embodiment, the coil 116 may be replaced with a laser configured to deliver radiation to the wick 114 to heat the aerosol generating liquid absorbed by the wick 114. The coil 116 and the first heater 108 may be connected to the battery using separate power lines, in order to allow the coil 116 and the first heater 108 to be powered independently.

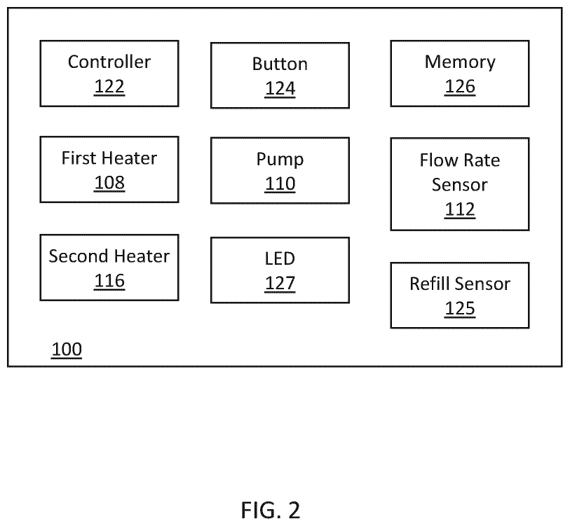

FIG. 2 is a schematic block diagram of a control system in an aerosol generating device in an embodiment of the invention.

The first aerosol generating device 100 further comprises a controller 122 provided internally to the housing 102 of the first aerosol generating device 100. The controller 122 is in electric communication with the other electronic components of the device, i.e. the components shown in FIG. 2, in order to control the operation of the first aerosol generating device 100. The controller 122 may be configured as one or more processors configured to execute instructions, provided on a chip positioned internally to the housing 102. The first aerosol generating device 100 further comprises a button 124 disposed on the outer surface of the housing 102 that is configured to receive an input from a user and relay the input to the controller 122. A memory 126 is provided for storing information relating to the flow rates of authorised aerosol generating fluids, and may also be provided in a chip housed internally to housing 102. A Light Emitting Diode 127, or LED 127, is provided on the external surface of the housing 102 for indicating to the user a status of the first aerosol generating device 100.

The first aerosol generating device 100 further comprises a refill sensor 125 configured to determine when the reservoir 104 has been refilled by the user. In one example, the refill sensor 125 may comprise electric contacts on a cap which must be removed in order to refill the reservoir. In another example, the refill sensor 125 may be configured to determine the level of fluid within the reservoir 104 using an optical system comprising a laser or an LED. The refill sensor 125 is configured to inform the controller 122 when the aerosol generating fluid has been replaced or refilled, so that the new fluid within the reservoir 104 can be authenticated.

Other input devices may be provided alternatively or in addition to the button 124 for receiving instructions from a user. For example, a puff sensor may be provided in order to detect airflow through the air channel (A) caused by a user inhaling through the mouthpiece 120. The controller 122 may be configured to power the coil 116 when the puff sensor detects airflow through the air channel (A), if the generation of an aerosol is already enabled. Similarly, other output devices may be provided alternatively or in addition to the LED 127 in order to inform the user of the status of the device, such as a vibration unit configured to provide haptic feedback.

An example usage of the first aerosol generating device 100 will now be described with reference to FIGS. 1 and 2. Prior to use of the first aerosol generating device 100, the user may refill the reservoir 104 with an aerosol generating fluid. The refill sensor 125 may detect that the reservoir 104 has been refilled. The user can press the button 124 to initiate, or ‘wake up’ the device. In response to the user pressing the button 124, the controller 122 infers that the user intends to start generating an aerosol, or start ‘vaping’. The controller 122 may receive a signal from the refill sensor 125 indicating that a new aerosol generating fluid has been provided and must be authorised. The controller 122 then instructs the first heater 108 to pre-heat a portion of aerosol generating fluid up to a predetermined temperature which is below the temperature of aerosol generation, preferably in the range of 40-70° C. The temperature sensor 109 may send a signal to the controller 122 when it detects that the aerosol generating fluid has reached the predetermined temperature. In response, the controller 122 may instruct the pump 110 to pump the pre-heated aerosol generating fluid through the flow rate sensor 112 for measuring. The flow rate sensor 112 measures the flow rate and provides the measured flow rate to the controller 122.

The memory 126 contains a list, or ‘look-up table’, of flow rates of authorised aerosol generating fluids as measured when they are pumped at the fixed pumping power of the pump 110 at the predetermined temperature. The controller 122 can perform a comparison between the measured flow rate and each flow rate stored in the memory 126. If the controller 122 determines a match, the controller 122 infers that the aerosol generating fluid is an authorised aerosol generating fluid. The controller 122 then enables the generation of an aerosol by enabling the provision of power to the coil 116. The user can press the button 124 a subsequent time to provide power to the coil 116, which heats and vaporises the aerosol generating fluid absorbed by the wick 114 to generate an aerosol. The user can then inhale the generated aerosol through the mouthpiece 120.

In another example embodiment, the button 124 may be used in conjunction with a puff sensor to control the generation of an aerosol. In such an example, the button 124 may be used only to initiate the authentication of the aerosol generating fluid. A switch on a power line between the battery and the coil 116 may be provided which is turned on by the controller 122 when the fluid is successfully authenticated. The controller 122 may then instruct the battery to provide power through the power line whenever the puff sensor detects airflow through the air channel (A).

Alternatively, if the controller 122 does not determine a match, then the controller 122 does not enable the provision of power to the coil 116. In this case, if the user presses the button 124 a subsequent time, power is not provided to the coil 116 and an aerosol is not generated. Similarly, if the aerosol generating device 100 comprises a puff sensor as described above, the detection of airflow through the air channel (A) by the puff sensor does not cause the controller 122 to instruct the battery to power the coil 116. A match may not be determined because the user has been sold a counterfeit aerosol generating fluid which has different properties from authorised aerosol generating fluids. For example, a counterfeit aerosol generating fluid may have a different ratio of propylene glycol to vegetable glycerine, which can affect the viscosity of the fluid, and hence the measured flow rate of the fluid. In another example, the aerosol generating fluid may contain additional, harmful, substances which also affect the flow rate in a similar manner. In this way, the user can be protected from unauthorised or unsafe aerosol generating fluids. In another example, the aerosol generating fluid may be an authorised fluid which is provided to the flow rate sensor 112 above the predetermined temperature. This may happen if a fault occurs which causes the device to overheat. In general, the viscosity of fluid is temperature dependent, and so an overly hot authorised fluid can be interpreted by the controller 122 as an unauthorised fluid. This advantageously protects the user from using an overheating device.

In other example embodiments, the flow rate of the aerosol generating fluid may be measured in other ways, without the use of the pump 110. For example, the fluid may be circulated within the reservoir 104 by a motorised wheel. The flow rate of the fluid may then be measured by a sensor within the reservoir 104 as the fluid is circulated within the reservoir 104.

In some embodiments, the controller 122 may be configured to perform a calculation of the viscosity of the aerosol generating fluid, based on the measured flow rate. Poiseille's law describes the relationship between the flow rate (Q) of laminar fluid flow in a tube of radius (r) and length (l), the pressure difference (ΔP) due to the pressure applied by a pump, and the viscosity (η) of the fluid:

$$Q = \frac{Δ P π {r}^{4}}{8 η l} \qquad ( Equation 1 )$$

In some embodiments, the controller 122 can use Equation 1 to calculate the viscosity (η) of the aerosol generating fluid based on the flow rate (Q) measured by the flow rate sensor 112. The radius (r) and length (l) of the conduit 106 can be stored as parameters in the memory 126. The pressure applied by the pump 110, or the pumping power, can also be stored in the memory 126 to enable the calculation to be performed by the controller 122. The controller 122 can then perform a comparison between the calculated viscosity and the viscosities of authorised aerosol generating fluids stored in the memory 126.

The temperature dependence of the viscosity (η) of a liquid can be described by the Andrade equation, which relates the viscosity (η) of the liquid to its temperature (T) and two liquid dependent coefficients (A) and (B):

η=Ae^{B/T} (Equation 2)

Equation 2 indicates how the measured or calculated viscosity of a liquid can be affected by temperatures, such as ambient temperatures. Equation 1, which relates the viscosity (η) and flow rate (Q), gives an indication of how ambient temperatures can also affect the measured flow rate of the aerosol generating fluid, provided the fluid is substantially a liquid.

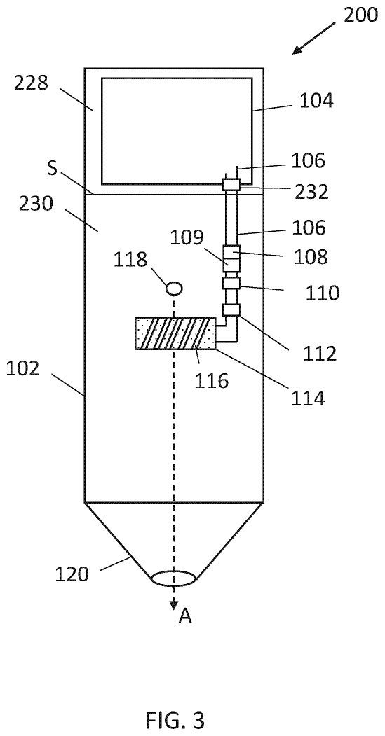

FIG. 3 is a cross-sectional schematic diagram of an aerosol generating device in a second embodiment of the invention.

A second aerosol generating device 200 is provided which comprises the same components as the first aerosol generating device 100. However, the second aerosol generating device 200 differs from the first aerosol generating device 100 in that the reservoir 104 is provided on a first cartridge 228 which is configured to removably attach to a reusable unit 230 at a connection surface (S). In this example embodiment, the first cartridge 228 is configured to be disposable and may be provided with an aerosol generating fluid present in the reservoir 104. The reusable unit 230 and the first cartridge 228 may be configured to attach using a screw-thread connection, a snap-lock connection, a magnetic connection, or any other mechanical connection. In an alternative embodiment, the first cartridge 228 may be housed in a chamber of the reusable unit 230 configured to receive the first cartridge 228. The refill sensor 125 may be configured to determine when the first cartridge 228 has been removed or replaced. In one example, the refill sensor 125 may be configured as electrical contacts at the connection surface (S). In this embodiment, the other components of the first aerosol generating device 100 described previously in reference to FIGS. 1 and 2 are provided on the reusable unit 230.

The first cartridge 228 further comprises a pierceable member 232 in fluid connection with the reservoir 104. The pierceable member 232 is configured to be pierced by the conduit 106 in order to bring the conduit 106 into fluid communication with the reservoir 104. In one example, the pierceable member 232 may comprise a thin sheet of rubber or plastic. The pierceable member 232 may be configured to form a hermetic seal around the conduit 106 in order to prevent leakage of the aerosol generating fluid. The skilled person would appreciate that other methods of enabling fluid connection between a disposable reservoir and the conduit 106 of the reusable unit 230 may be provided in other embodiments.

In use, the user can attach the reusable unit 230 to the first cartridge 228 and pierce the pierceable member 232 using the exposed end of the conduit 106. The aerosol generating fluid can then be drawn from the reservoir 104 through the conduit 106 using the pump 110, in order to be pre-heated by the first heater 108 and measured by the flow rate sensor 112. The aerosol generating fluid contained within the reservoir 104 may then be verified by the controller 122, as described in reference to the first aerosol generating device 100. The second aerosol generating device 200 thus enables the authenticity of the fluid contained within disposable cartridges to be verified before consumption by a user. Additionally, counterfeit versions of the reusable unit 230 may be identified when used in conjunction with an authentic first cartridge 228. A counterfeit version of the reusable unit 230 may have a conduit 106 with a larger or smaller radius compared to authentic reusable units. This can affect the flow rate of the aerosol generating fluid through the conduit 106. Thus, a counterfeit reusable unit 230 may be unable to measure the same flow rate as would be measured by an authentic reusable unit 230, at the predetermined temperature.

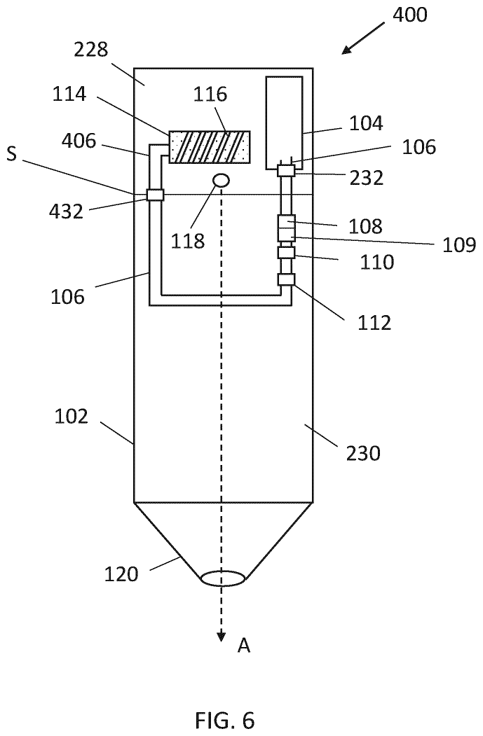

FIG. 6 is a cross-sectional schematic diagram of an aerosol generating device in a fourth embodiment of the invention.

A fourth aerosol generating device 400 is provided which comprises the same components as the second aerosol generating device 200. However, the fourth aerosol generating device 400 differs from the second aerosol generating device 200 in that the wick 114 and the coil 116 are provided in the first cartridge 228 along with the reservoir 104. This enables the wick 114 and the coil 116 to be conveniently replaced by replacing the first cartridge 228 with a fresh cartridge. Additionally, the cost of the first cartridge 228 is minimised because the first heater 108, the temperature sensor 109, the pump 110 and the flow rate sensor 112 are provided on the reusable unit 230. To facilitate the repositioning of the wick 114 and coil 116 onto the first cartridge 228, a cartridge conduit 406 and a cartridge valve 432 is provided in the first cartridge 228. The cartridge conduit 406 fluidically connects the wick 114 and the cartridge valve 432. The cartridge valve 432 provides a sealable connection between the conduit 106 and the cartridge conduit 406. In one example, the cartridge valve 432 may comprise an O-ring connection configured to form a hermetic seal about the conduit 106 when an exposed end of the conduit 106 is pushed through the O-ring connection. The air inlet 118 is provided on a housing of the first cartridge 228. The first cartridge 228 may comprise an additional air channel which fluidically connects to the air channel (A) of the reusable unit 230 via an aperture (not shown), to enable the generated aerosol to be carried to the mouthpiece 120. Electrical contacts are provided at the connection surface (S) to connect the battery, which is provided in the reusable unit 230, to the coil 116.

In use, the user can attach the first cartridge 228 to the reusable unit 230 and pierce the pierceable member 232 using an exposed end of the conduit 106. At the same time, the user can push a second exposed end of the conduit 106 through the cartridge valve 432, thereby bringing the reservoir 104 into fluid connection with the wick 114. The aerosol generating fluid can then be drawn from the reservoir 104 through the conduit 106 using the pump 110, in order to be pre-heated by the first heater 108 and measured by the flow rate sensor 112. The aerosol generating fluid contained within the reservoir 104 may then be verified by the controller 122, as described in reference to the first aerosol generating device 100. Once the aerosol generating fluid has been verified, the pump 110 can pump the aerosol generating fluid through the cartridge valve 432 and the cartridge conduit 406 towards the wick 114. The fourth aerosol generating device 400 thus enables the authenticity of the fluid contained within disposable cartridges to be verified before consumption by a user. Additionally, the wick 114 and the coil 116 can be conveniently replaced by replacing the first cartridge 228.

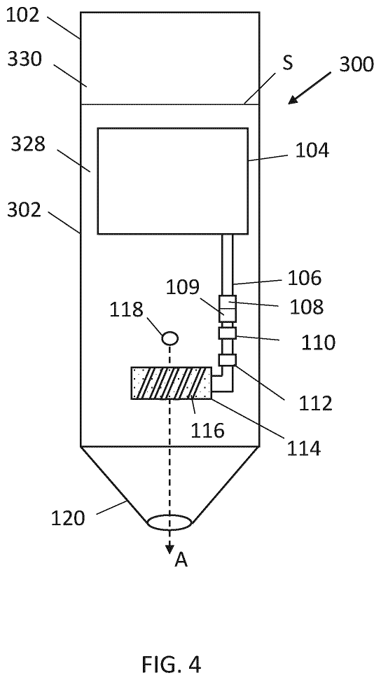

FIG. 4 is a cross-sectional schematic diagram of an aerosol generating device in a third embodiment of the invention.

A third aerosol generating device 300 is provided which comprises the same components as the first aerosol generating device 100. However, the third aerosol generating device 300 differs from the first aerosol generating device 100 in that the controller 122, the button 124, the memory 126, the LED 127, and the battery are provided on a reusable control unit 330 housed by the housing 102. The control unit 330 is configured to removably attach to a second cartridge 328 at a connection surface (S). In this embodiment, the air inlet 118 is provided on a cartridge housing 302 which houses the internal components of the second cartridge 328. The refill sensor 125 is configured to determine when the second cartridge 328 has been removed or replaced. In one example, the refill sensor 125 may be configured as electrical contacts at the connection surface (S). The other components of the first aerosol generating device 100 as described with reference to FIGS. 1 and 2 are provided on the second cartridge 328.

The control unit 330 and the second cartridge 228 further comprise electrical contacts (not shown) provided at the connection surface (S), positioned to make contact when the control unit 330 and the second cartridge 228 are attached. The electrical contacts are configured to bring the controller 122 and the battery in electrical connection with the first heater 108, the temperature sensor 109, the pump 110, the flow rate sensor 112, and the coil 116. This enables the delivery of instructions from the controller 122 and power from the battery to the components on the second cartridge 328. The coil 116 cannot receive power from the battery unless the control unit 330 and the second cartridge 328 are attached. Thus, the electrical contacts also function as control electronics which prevent the generation of an aerosol unless the control unit 330 and the second cartridge 328 are connected.

The control unit 330 and the second cartridge 328 may be configured to attach at the connection surface (S) using a screw-thread connection, a snap-lock connection, a magnetic connection, or any other mechanical connection as is known in the art.

The second cartridge 328 may be configured as a refillable cartridge. In one example embodiment, the reservoir 104 may be accessed by a screw cap on the second cartridge 328 and refilled by opening a valve in fluid connection with the reservoir 104 which enables aerosol generating fluid to be provided through the valve. Alternatively, the second cartridge 328 may be configured as a disposable cartridge.

In use, the user may attach the control unit 330 and the second cartridge 328, and press the button 124 on the control unit 330 to initiate the verification of the fluid within the reservoir 104. The controller 122 can communicate with the first heater 108, the temperature sensor 109, the pump 110 and the flow rate sensor 112 via the electrical contacts provided on the connection surface (S) in order to verify the fluid within the reservoir 104, as described previously in reference to FIGS. 1 and 2. In the embodiment of FIG. 4, the reservoir 104 is in fluid connection with the wick 114 without the use of a seal or valve between two detachable components. This advantageously avoids the possibility of leakage at the seal.

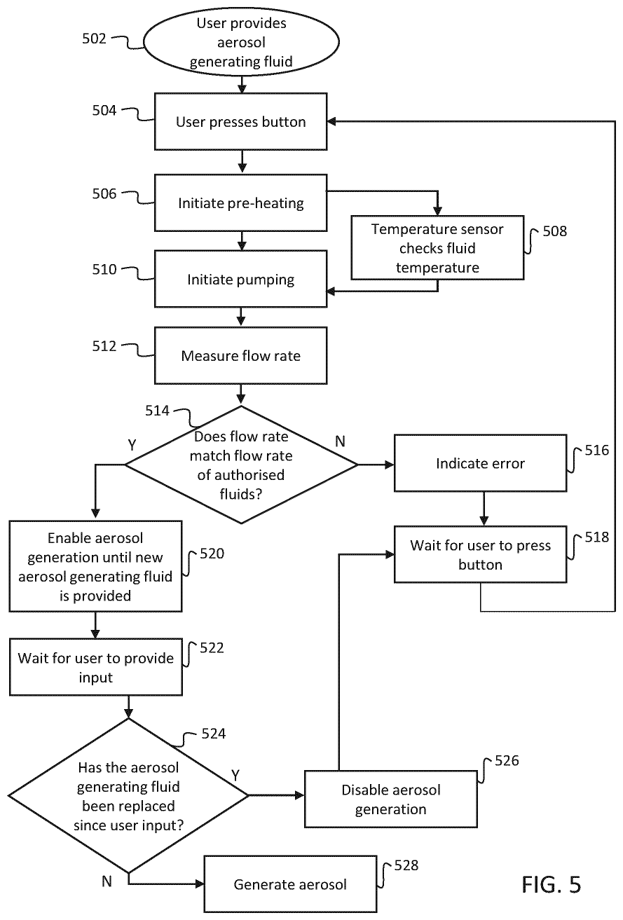

FIG. 5 is a flowchart showing a control sequence in an embodiment of the invention. Operation of the first aerosol generating device 100 will now be described in greater detail with reference to FIG. 5. However, the steps below also describe the operation of the second aerosol generating device 200, the third aerosol generating device 300, and the fourth aerosol generating device 400.

At step 502, the user provides the first aerosol generating device 100 with the aerosol generating fluid by refilling the reservoir 104. At this step, the device may be in an inactive state.

Step 502 may be carried out differently depending on which embodiment is being used by the user. In the embodiment of FIG. 1, the user may refill the reservoir 104 using an external reservoir. In the embodiments of FIG. 3 or FIG. 6, the user may attach the first cartridge 228 to the reusable unit 230, thereby bringing the reservoir 104 into fluid communication with the conduit 106. In the embodiment of FIG. 4, the user may attach a refilled or fresh second cartridge 328 to the control unit 330, thereby bringing the components of the second cartridge 328 into electric communication with the battery and the controller 122 provided within the control unit 330. In any case, the refill sensor 125 detects when the aerosol generating fluid has been replaced and informs the controller 122 via a control signal. At step 504, the user presses the button 124 to initiate, or ‘wake up’, the device. The button 124 detects the input from the user and sends a control signal to the controller 122, indicating to the controller 122 that the user intends to generate an aerosol, or start ‘vaping’. The user may be required to initiate the authentication by pressing the button 124 for an extended time period, for example 2 or 5 seconds. The controller 122 initiates the authentication process because a control signal has been received from the refill sensor 125.

At step 506, the controller 122 initiates the first heater 108. The first heater 108 begins to heat a portion of the aerosol generating fluid within the conduit 106 to a predetermined temperature. The predetermined temperature is preferably higher than 35° C., so that it is higher than most ambient temperatures a user is likely to encounter. More preferably, the predetermined temperature is above 40° C. so that the predetermined temperature can safely be considered higher than the ambient temperature. This reduces the likelihood of a falsely detecting an authorised fluid as an unauthorised fluid, or vice versa, which can occur when the aerosol generating fluid is not pre-heated before the flow rate is measured. The predetermined temperature is preferably below 70° C. It has been found that pre-heating the fluid above this temperature can decrease the viscosity of the fluid enough to negatively impact the efficiency of the pump 110. Furthermore, implementing a predetermined temperature below 70° C. increases the efficiency of the first aerosol generating device 100 because the first heater 108 is not operating at higher temperatures than may be necessary to achieve a more reliable authentication.

Step 508 is an optional step which in which the temperature of the aerosol generating fluid in the conduit 106 is measured by the temperature sensor 109. The temperature sensor 109 may continuously provide the controller 122 with the temperature of the aerosol generating fluid. The controller 122 may be configured to initiate step 510 when the temperature sensor 109 measures a temperature at or above the predetermined temperature.

Optionally, step 508 is not implemented. In this case, the first aerosol generating device 100 may be configured to power the first heater 108 to pre-heat the fluid for a predetermined pre-heating time which is long enough to ensure the aerosol generating fluid reaches the predetermined temperature. This can reduce the cost and complexity of the device by avoiding the need for a temperature sensor 109.

At step 510, the controller 122 sends a control signal to the pump 110 to initiate pumping. The pump 110 then pumps the aerosol generating fluid through the conduit 106 towards the flow rate sensor 112.

At step 512, the flow rate sensor 112 measures the flow rate of the aerosol generating fluid and sends the measured flow rate to the controller 122.

At step 514, the controller 122 receives the measured flow rate and performs a comparison of the flow rate to a list of flow rates stored in the memory 126 which correspond to authorised aerosol generating fluids. In particular, the stored flow rates correspond to flow rates of authorised fluids as measured when pumped at the specific pumping power of the pump 110 at the predetermined temperature. The controller 122 may be configured to allow for a pre-determined tolerance, above or below which the measured flow rate may be considered to match a stored flow rate.

In other embodiments, the controller 122 may be configured to calculate the viscosity of the aerosol generating fluid based on the measured flow rate, the predetermined temperature, and the fixed pumping power of the pump 110, as described previously in reference to Equation 1. The memory 126 may be configured to store the viscosities of authorised aerosol generating fluids, as measured when pumped at the specific pumping power of the pump 110 at the predetermined temperature. The controller 122 may then verify the measured aerosol generating fluid based on a comparison of the calculated viscosity with the stored viscosities.

Returning to step 514, the controller 122 may determine that the measured flow rate does not match any of the flow rates stored in the memory 126. The controller 122 then proceeds to step 516.

At step 516, the controller 122 instructs the LED 127 to indicate to the user that the aerosol generating fluid is not an authorised aerosol generating fluid. In one example, the LED 127 may flash with a particular frequency or colour which indicates that the measured fluid is not determined to be an authorised fluid. In practice, this step could also be reached if a fault has occurred which causes the device to overheat. Thus, an authentic, or safe, aerosol generating fluid may be falsely identified as an unauthorised fluid. Nonetheless, the user is advantageously discouraged from using the overheating device. In some example embodiments, an additional sensor may be provided to check the temperature of the device when this step occurs. In such embodiments, if the device is found to be overheating, the controller 122 can instruct the LED 127 to indicate this to the user. In a further example, a vibration unit may be provided and configured to provide haptic feedback at this step, alternatively or in addition to the operation of the LED 127.

At step 518, the first aerosol generating device 100 may return to an inactive state until the user presses the button 124 again. In practice, the user may press the button 124 after they have obtained an authorised aerosol generating fluid and provided the reservoir 104 with this fluid. Once the user presses the button 124, the controller 122 may return to step 504 to begin the verification process again. The user may be required to press the button 124 for an extended time period, such as 2 or 5 seconds, to re-initiate the authentication process.

Alternatively, at step 514, the controller 122 may determine a match between the measured flow rate and any of the stored flow rates. The controller 122 then proceeds to step 520.

At step 520, the controller 122 enables the generation of an aerosol until the refill sensor 125 detects that the reservoir 104 has been refilled. While the generation of an aerosol is enabled, the user can initiate the provision of electric current to the coil 116 by providing an input to the first aerosol generating device 100. In one example, the input may be a short or quick press of the button 124. In another example, the input may be inhalation through the mouthpiece 120 which is detected by a puff sensor.

When step 520 is reached using the second aerosol generating device 200, the third aerosol generating device 300, or the fourth aerosol generating device 400, the controller 122 may be configured to enable the generation of an aerosol until the refill sensor 125 detects that the first cartridge 228 or the second cartridge 328 has been removed or replaced.

At step 522, the user provides an input to the first aerosol generating device 100 using the button 124, or another input device such as a puff sensor, to instruct the controller 122 to provide power to the coil 116.

Step 524 occurs in response to the detection of a user input at step 522. At step 524, if the controller 122 determines that the user has refilled or replaced the aerosol generating fluid since the last successful authentication, then the generation of an aerosol is disabled at step 526. The controller 122 may then return to step 518 to begin the verification process again. Optionally, the controller 122 may instruct the LED 127 to indicate to the user that a new aerosol generating fluid has been detected by the refill sensor 125, and that the new fluid must be authorised before the generation of an aerosol can be re-enabled.

Alternatively, if the user does not refill or replace the aerosol generating fluid before providing an input at step 522, then the controller 122 proceeds to step 528.

At step 528, the controller 122 determines that the user has provided an input while the generation of an aerosol is enabled and allows the battery to provide power to the coil 116. The powered coil 116 generates heat which vaporises the aerosol generating fluid absorbed by the wick 114. The user can then draw air through the air inlet 118, via mouthpiece 120, which carries the generated aerosol to the user via the air channel (A). The controller 122 may return to step 522. The user can then provide further inputs, such as a short press of the button 124 or an inhalation through the mouthpiece 120 which is detected by a puff sensor, to generate an aerosol at will until the user replaces the aerosol generating fluid. The controller 122 may be configured to instruct the pump 110 to continually supply the wick 114 with aerosol generating fluid on each subsequent detection of an input, in order to keep the wick 114 sufficiently saturated with fluid.

The presence of an error is indicated at step 516, however in other examples other operational statuses may be indicated after certain steps. For example, after the generation of an aerosol has been enabled, the controller 122 may instruct the LED 127 to indicate to the user that the device is ready to generate an aerosol. Similarly, at step 526, the controller 122 may also instruct the LED 127 to indicate to the user that the generation of an aerosol has been disabled because the reservoir 104 has been refilled.

In some embodiments of the first aerosol generating device 100, the second aerosol generating device 200, the third aerosol generating device 300, and the fourth aerosol generating device 400, the aerosol generating fluid may comprise entirely of a liquid. In such cases, the aerosol generating devices may be optimised specifically for the pumping, heating, measuring, or otherwise use of a liquid.

1. An aerosol generating device configured to generate an aerosol for inhalation by a user, comprising:
a heater configured to heat an aerosol forming fluid to a predetermined temperature;
a sensor configured to measure a parameter related to a flow rate of the heated aerosol forming fluid; and
a controller configured to enable or disable the generation of an aerosol based on the measured parameter.

2. The aerosol generating device of claim 1, further comprising a pump configured to pump the aerosol forming fluid.

3. The aerosol generating device of claim 2, wherein the pump is configured to provide pumping at a fixed pumping power.

4. The aerosol generating device of claim 1, wherein the controller is further configured to calculate viscosity of the aerosol forming fluid based on the measured parameter which is related to the flow rate, and to enable or disable the generation of the aerosol based on the calculated viscosity.

5. The aerosol generating device of claim 1, wherein the predetermined temperature is above 35° C.

6. The aerosol generating device of claim 1, further comprising a memory configured to store a value associated with the measured parameter which is related to the flow rate, and wherein the controller is configured to enable or disable the generation of an aerosol based on a comparison with the stored value.

7. The aerosol generating device of claim 1, further comprising a temperature sensor configured to determine a temperature of the aerosol forming fluid.

8. The aerosol generating device of claim 1, further comprising a reservoir configured to contain an aerosol forming fluid.

9. The aerosol generating device of claim 8, wherein the reservoir is provided on a cartridge.

10. The aerosol generating device of claim 9, comprising a reusable unit, wherein:
the reusable unit and the cartridge are configured to be attachable and detachable from one another; and
the controller is provided on the reusable unit.

11. The aerosol generating device of claim 10, further comprising a pump configured to pump the aerosol forming fluid, wherein the sensor, the pump and the heater are provided on the cartridge, and wherein the cartridge is configured to be refillable.

12. The aerosol generating device of claim 10, further comprising control electronics configured to permit the generation of an aerosol when the reusable unit and the cartridge are attached.

13. A method of operating the aerosol generating device according to claim 1 to generate an aerosol, comprising the steps of:
heating an aerosol forming fluid to a predetermined temperature;
measuring a parameter which is related to a flow rate of the heated aerosol forming fluid; and
enabling or disabling the generation of an aerosol based on the measured parameter.

14. A non-transitory computer readable medium comprising executable instructions that, when executed by a processor on the aerosol generating device according to claim 1, cause the aerosol generating device to perform steps comprising:
heating an aerosol forming fluid to a predetermined temperature;
measuring a parameter which is related to a flow rate of the heated aerosol forming fluid; and
enabling or disabling generation of an aerosol based on the measured parameter.
